(19) United States
(12) Patent Application Publication
(10) Pub. No.: US 2013/0027971 A1
(43) Pub. Date: Jan. 31, 2013

(54) DAZZLE PREVENTION LIGHTING FIXTURE WITH LIGHT GUIDE MEANS TO DISPERSE EMITTED LIGHT UNIFORMLY

(71) Applicants: Jih Sheng Huang, Guishan Township (TW); Chi-Fu Chuang, Guishan Township (TW); Yu-Shen Ting, Guishan Township (TW); Chih Ming Tien, Guishan Township (TW)

(72) Inventors: Jih Sheng Huang, Guishan Township (TW); Chi-Fu Chuang, Guishan Township (TW); Yu-Shen Ting, Guishan Township (TW); Chih Ming Tien, Guishan Township (TW)

(73) Assignee: ENLIGHT CORPORATION, Guishan Township (TW)

(21) Appl. No.: 13/193,603

(22) Filed: Jul. 29, 2011

(51) Int. Cl. F21V 7/04

(52) U.S. Cl. 362/607

(57) ABSTRACT

A dazzle prevention lighting fixture includes a holder frame, two light sources bilaterally mounted in the holder frame, and a light guide, which includes a diffuser prism sheet set between the light sources and adapted for diffusing emitted light rays from the light sources into a uniform light source and a back reflection sheet covered on the back side of the diffuser prism sheet and adapted for reflecting the diffused light rays from the diffuser prism sheet toward a predetermined target unit.

### BACKGROUND OF THE INVENTION

1. Field of the Invention

The present invention relates to a lighting technology and more particularly, to a dazzle prevention lighting fixture with light guide means to disperse emitted light uniformly in the predetermined light projection angle.

2. Description of the Related Art

LEDs (light emitting diodes) are nowadays intensively used in a variety of lighting fixtures for the advantages of assorted colors for selection, environmentally friendly features, power saving and long service life. However, regular LEDs have the drawback of small radiation area due to high concentration of light rays. A direct use of conventional LEDs may dazzle the eyes of people. When using a LED lamp for the purpose of reading or for direct illumination, the bulb of the LED lamp cannot be a clear type and must be blurred, avoiding dazzling. Making the surface of a bulb for LED lamp blurred complicates the fabrication. Further, using a blurred bulb for a LED lamp relatively lowers the brightness, leading to energy waste.

### SUMMARY OF THE INVENTION

The present invention has been accomplished under the circumstances in view. It is one object of the present invention to provide a dazzle prevention lighting fixture with light guide means to disperse emitted light uniformly in the predetermined light projection angle, avoiding excessive concentration of light and avoiding dazzling user's eyes.

To achieve this and other objects of the present invention, a dazzle prevention lighting fixture comprises a holder frame, two light sources bilaterally mounted in the holder frame, and a light guide for diffusing light rays emitted by the light source. The light guide comprises a diffuser prism sheet set between the light sources and adapted for diffusing emitted light rays from the light sources into a uniform light source, and a back reflection sheet covered on the back side of the diffuser prism sheet and adapted for reflecting the diffused light rays from the diffuser prism sheet toward a predetermined target unit.

### BRIEF DESCRIPTION OF THE DRAWINGS

FIG. 1 is an oblique front elevational view of a dazzle prevention lighting fixture in accordance with the present invention.

FIG. 2 is an exploded view of the dazzle prevention lighting fixture in accordance with the present invention.

FIG. 3 is an enlarged view of Part A of FIG. 2.

FIG. 4 is an oblique back elevational view of the dazzle prevention lighting fixture in accordance with the present invention.

FIG. 5 is a sectional side view of the dazzle prevention lighting fixture in accordance with the present invention.

FIG. 6 is an enlarged view of Part B of FIG. 5.

FIG. 7 is a schematic sectional side view of the present invention illustrating an operation status of the dazzle prevention lighting fixture.

### DETAILED DESCRIPTION OF THE PREFERRED EMBODIMENT

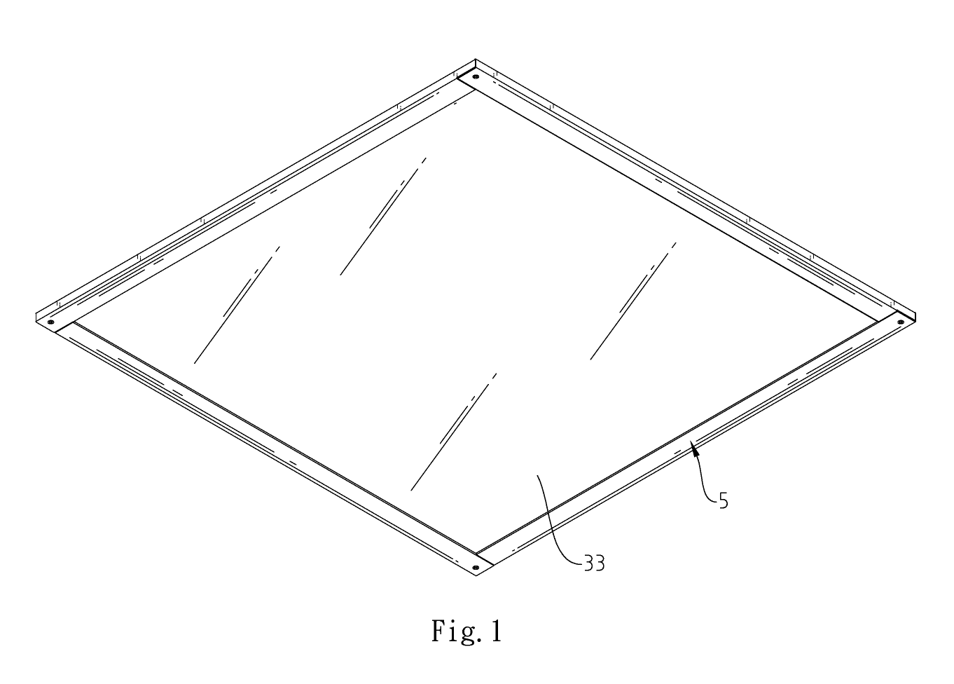

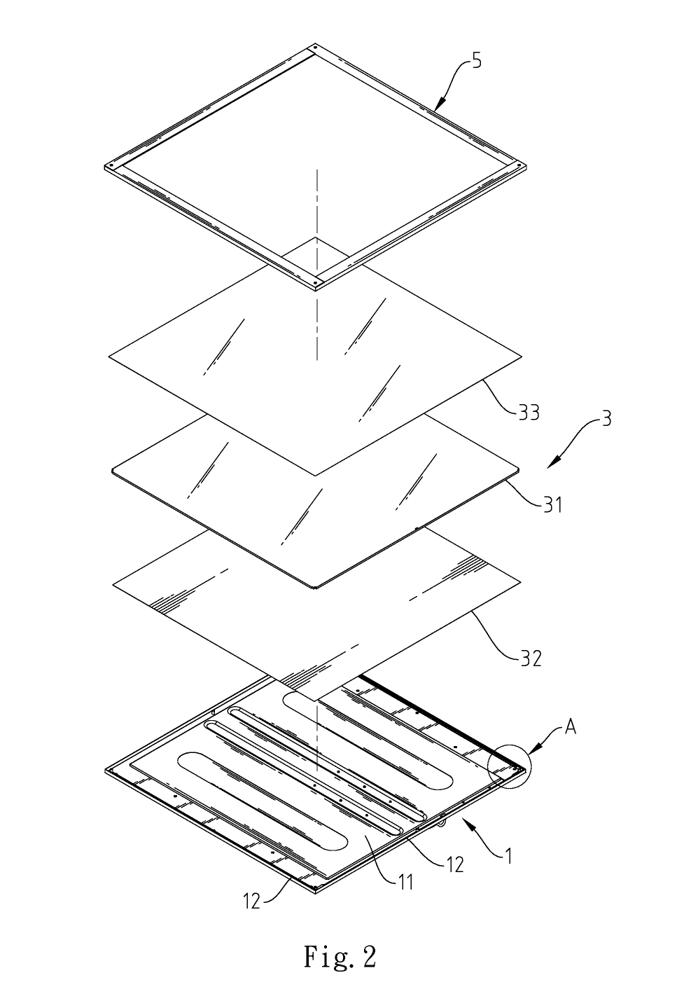

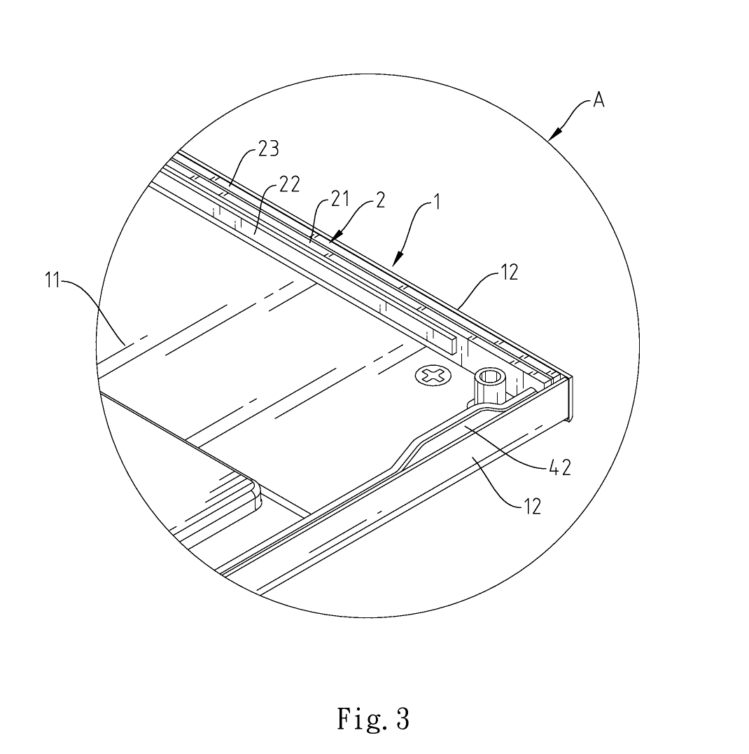

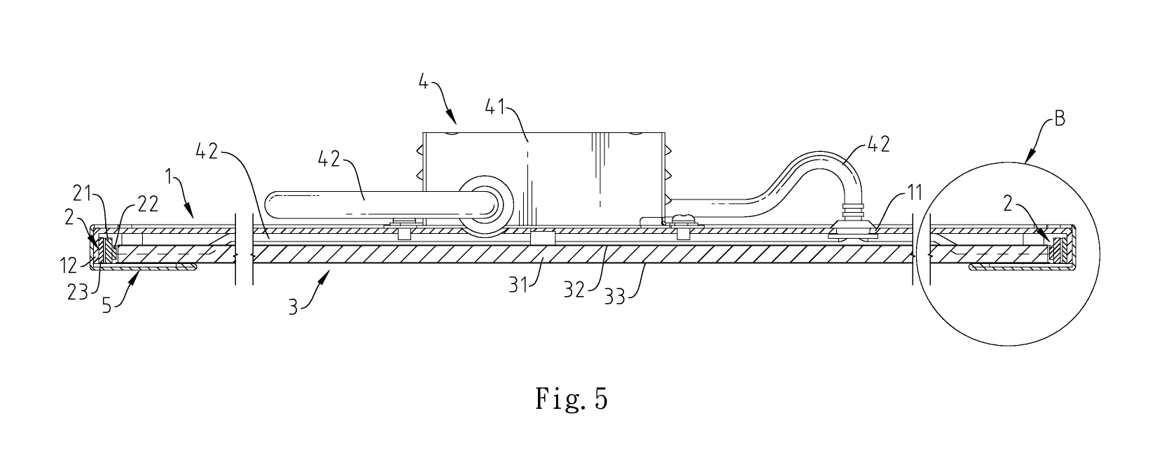

Referring to FIGS. 1-5, a dazzle prevention lighting fixture in accordance with the present invention is shown comprising a holder frame 1, two light sources 2, a light guide 3, a power supply device 4 and a packing frame 5.

The holder frame 1 comprises a flat rectangular base 11, and a rim 12 perpendicularly extended along the four sides of the flat rectangular base 11.

Each light source 2 comprises a circuit board 21 and a plurality of LEDs (light emitting diodes) 22 installed in the circuit board 21. The circuit board 21 is prepared by, for example, an aluminum substrate. The circuit boards 21 of the light sources 2 are respectively bonded to the rim 12 at two opposite sides by a thermal adhesive 23.

The light guide 3 is accommodated in the holder frame 1 and set between the two light sources 2, comprising a diffuser prism sheet 31 having a microstructure on the surface thereof, a back reflection sheet 32 and a front protective sheet 33. The diffuser prism sheet 31 is sandwiched between the back reflection sheet 32 and the front protective sheet 33.

The power supply device 4 is mounted in the back side of the flat rectangular base 11 of the holder frame 1 remote from the rim 12 and electrically connected with the light sources 2 with electrical wires 42, comprising a power controller 41 for power control.

The packing frame 5 is a rectangular open frame packed on the rim 12 of the holder frame 1 to hold the light guide 3 in place.

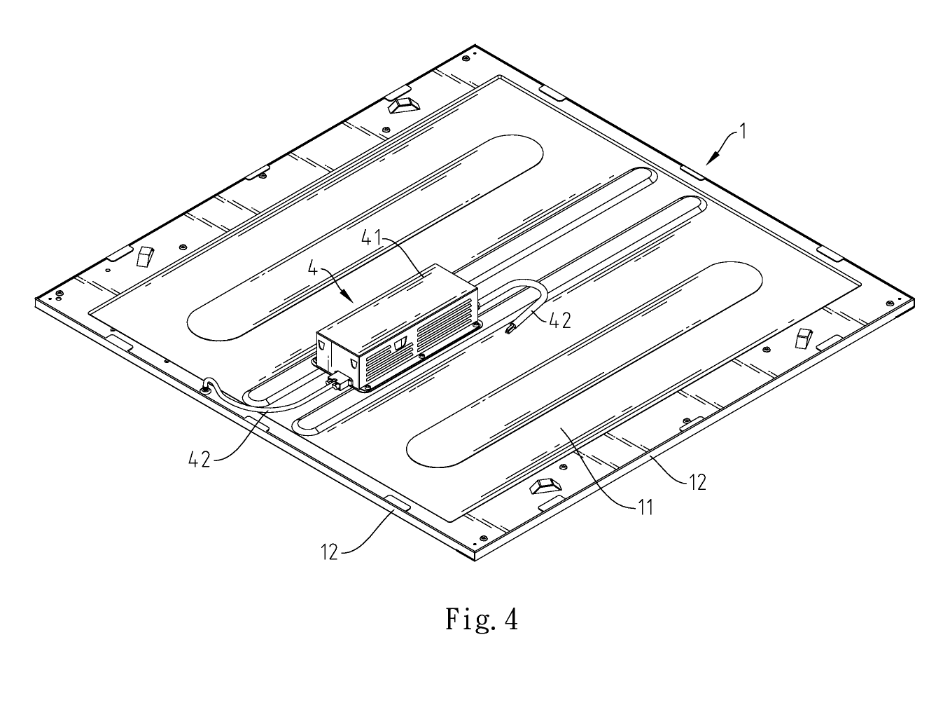

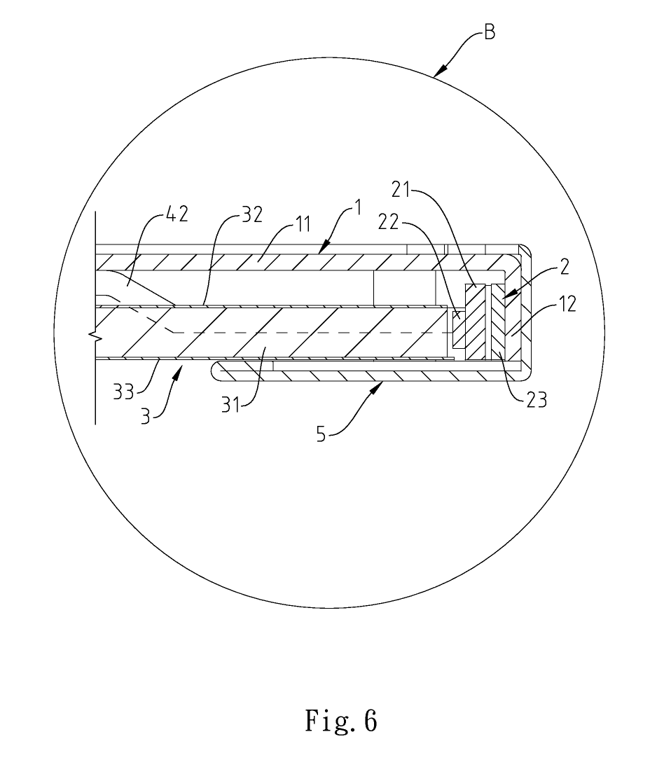

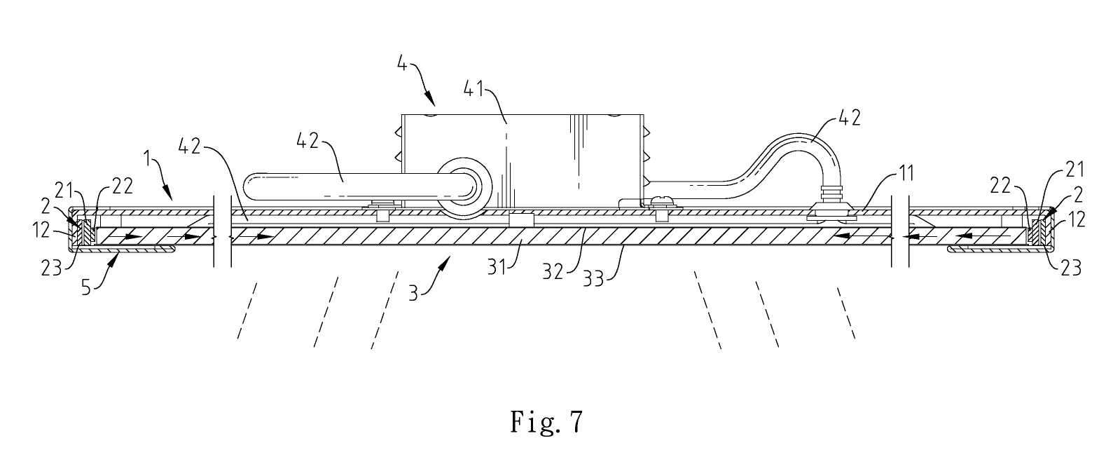

Referring to FIGS. 6 and 7 and FIGS. 4 and 5 again, during application of the dazzle prevention lighting fixture, the power controller 41 of the power supply device 4 is electrically connected to an external power source, for example, city power supply, enabling electricity to be transmitted through the electrical wires 42 to the light sources 2. When the dazzle prevention lighting fixture is powered-on, the LEDs 22 are turned on to emit light, enabling light rays to fall upon the respective lateral sides of the diffuser prism sheet 31. At this time, the diffuser prism sheet 31 disperses incident light rays in all directions and reflected by the back reflection sheet 32 through the front protective sheet 33 toward a predetermined target area.

Further, the front protective sheet 33 can be a transparent sheet member or any color of sheet member that admits light and protects the diffuser prism sheet 31 against scratch.

In general, the invention provides a dazzle prevention lighting fixture, which uses a diffuser prism sheet 31 to disperse light rays emitted by LEDs 22 in all directions and a back reflection sheet 32 to reflect uniformly dispersed light toward a predetermined target area, avoiding concentration of light and the problem of eye dazzling.

Further, when light rays are projected through the front protective sheet 33 toward the predetermined target area, they form one single light source without causing ghost images.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A dazzle prevention lighting fixture, comprising a holder frame, two light sources bilaterally mounted in said holder frame, and light guide means mounted in said holder frame in between said two light sources and adapted for guiding emitted light rays from said two light sources toward a predetermined target area, wherein said light guide means comprises a diffuser prism sheet set between said two light sources and adapted for diffusing emitted light rays from said two light sources, and a back reflection sheet mounted in said holder base at a back side of said diffuser prism sheet and adapted for reflecting diffused light rays from said diffuser prism sheet toward said predetermined target area.

2. The dazzle prevention lighting fixture as claimed in claim 1, wherein said light guide means further comprises a front protective sheet covered on a front side of said diffuser prism sheet opposite to said back reflection sheet for letting the light rays reflected by said back reflection sheet pass toward said predetermined target area.

3. The dazzle prevention lighting fixture as claimed in claim 1, wherein said holder frame comprises a flat rectangular base and a rim perpendicularly extending along four sides of said flat rectangular base; said two light sources are mounted at said rim at two opposite sides inside said holder frame.

4. The dazzle prevention lighting fixture as claimed in claim 3, wherein each said light source comprises a circuit board bonded to said rim and a plurality of light emitting diodes installed in said circuit board.

5. The dazzle prevention lighting fixture as claimed in claim 1, further comprising a power supply device mounted at a back side of said holder frame, said power supply device comprising two electrical wires respectively connected to said two light sources, and a power controller electrically connectable to an external power source for controlling the supply of electricity to said two light sources.

6. The dazzle prevention lighting fixture as claimed in claim 1, further comprising a packing frame packed on the border area of said holder frame to hold said light guide means and said two light sources in said holder frame.

7. The dazzle prevention lighting fixture as claimed in claim 1, wherein said light guide means comprises a microstructure on the surface thereof.
